(19) United States
(12) Patent Application Publication
(10) Pub. No.: US 2019/0371034 A1
(43) Pub. Date: Dec. 5, 2019

(54) System to Manipulate Characters, Scenes, and Objects for Creating an Animated Cartoon and Related Method

(71) Applicants: John Feghali, Pittsburgh, PA (US); Fadi Alchoufete, Pittsburgh, PA (US); Chase Dudley, Pittsburgh, PA (US); Mathew Hallberg, Pittsburgh, PA (US); Kevin Marroquin, Pittsburgh, PA (US); Lloyd Wright, Coraopolis, PA (US)

(72) Inventors: John Feghali, Pittsburgh, PA (US); Fadi Alchoufete, Pittsburgh, PA (US); Chase Dudley, Pittsburgh, PA (US); Mathew Hallberg, Pittsburgh, PA (US); Kevin Marroquin, Pittsburgh, PA (US); Lloyd Wright, Coraopolis, PA (US)

(21) Appl. No.: 16/430,065

(22) Filed: Jun. 3, 2019

Related U.S. Application Data
(60) Provisional application No. 62/679,683, filed on Jun. 1, 2018.
(60) Provisional application No. 62/758,187, filed on Nov. 9, 2018.

(51) Int. Cl. G06T 13/40; G06T 13/60; A63H 33/42

(52) U.S. Cl. CPC G06T 13/40; A63H 33/42; G06T 13/60

(57) ABSTRACT

A system allows its users to manually move about a plurality of characters, before one or more prop scenes, in front of a physical (or digital) background scene. Using a holder/stand with a specially angled mirror, a device on that holder/stand is able to record real time movements and interactions between the characters and/or prop objects. A method for making animated videos with this system is also disclosed.

### CROSS REFERENCE TO RELATED APPLICATIONS

This application is a perfection of: U.S. Provisional Ser. No. 62/679,683 filed on Jun. 1, 2018, and U.S. Provisional Ser. No. 62/758,187 filed on Nov. 9, 2018, both disclosures of which are fully incorporated herein.

### BACKGROUND OF THE INVENTION

### 1. Field of the Invention

This invention relates to systems and methods for creating animated videos. More particularly, it relates to one or more systems that allow its users to manually move about a plurality of characters, before one or more prop scenes, in front of a physical (or digital) background scene. Using a novel device holder/stand with a specially angled mirror, the device is able to record using computer vision REAL TIME movements and interactions between movable characters and/or physical or digital prop objects.

### 2. Relevant Art

Various subcomponents of this system and method may be covered by patents. Applicants do not claim to have invented “green screen” technologies or smart device (phone or tablet) recording per se. The closest found “art” to this concept concerns Microsoft's U.S. Pat. No. 8,325,192 and Motion Games' U.S. Pat. No. 8,614,668. This invention distinguishes over both, however. Microsoft, for instance, uses an image capture device in communication with the processor and arranged to capture images of animation components. By contrast, this invention captures a real time video stream of the physical objects that are moving in a predefined space in front of our stand that has a mirror system. That stand-with-mirror system changes the field of vision for the camera of a smart device so that the latter can be placed at an angle while still seeing what is in front of its camera in somewhat of a hands-free augmented reality. Compared to the prior art found to date, this invention uses the physical position and speed of movement of our characters in the real world to create digital interactions that are important for creating animated cartoons that match the details inputted by a team of experienced cartoon producers. The relative positions of the physical characters affect the facial and body movements of our characters. It will also affect the sounds and digital environments that surround the digital characters being represented on the digital screen (as an alias for the real world, physical characters).

### SUMMARY OF THE INVENTION

This invention addresses a system for allowing an inexperienced user to create high quality, animated cartoons through the specially held camera component of his/her Smart Device. It provides a setup that allows manipulation of more than one character, prop object or scene at the same time while creating and recording the video, hands-free.

### BRIEF DESCRIPTION OF THE DRAWINGS

Further features, objectives and advantages of this invention will be clearer when reviewing the following detailed description made with reference to the accompanying drawings in which:

FIG. 1 is a top, right perspective view of a first embodiment of the system having a plurality of rotationally alternating rear screens or backgrounds;

FIG. 2 is a top, right perspective view of a second embodiment showing a device holder and base using a digitally derived characters background;

FIG. 3A is a right, front perspective view of one embodiment of device holder with its forward angled mirror and telescopic base supports retracted therebeneath;

FIG. 3B is a right, front perspective view of the device holder from FIG. 3A with its base supports extended and a background sheet about to be secured in the forward most clips thereof; and

FIG. 3C is an exploded perspective view of a whole system with one of two representative recording devices shown to the left of the device holder having its background support arms fully extended.

### DETAILED DESCRIPTION OF PREFERRED EMBODIMENTS

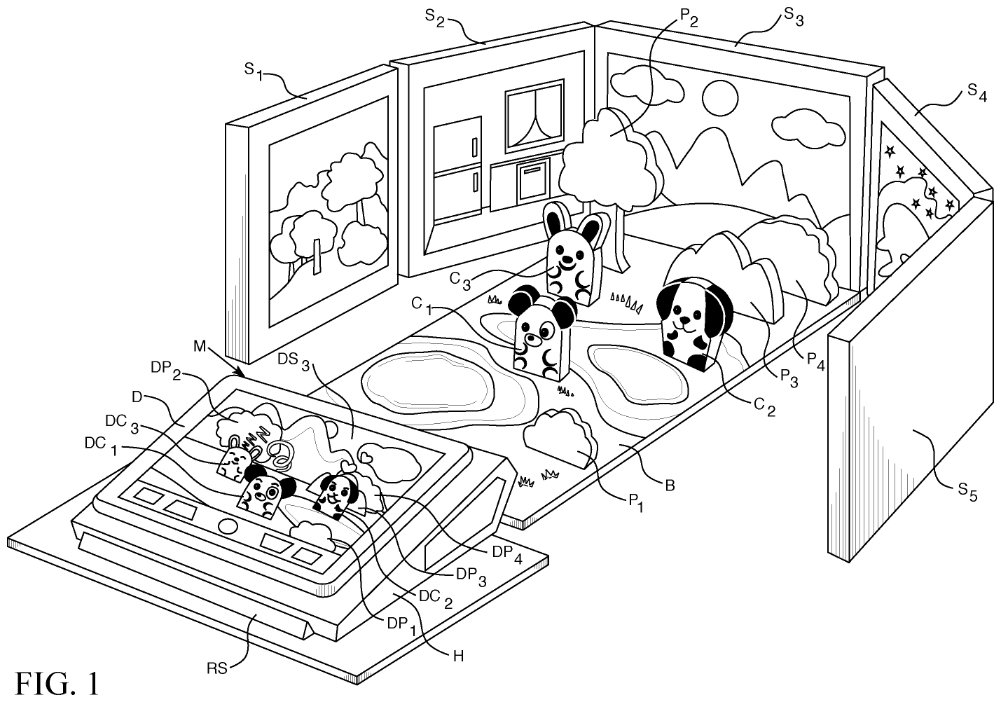

The invention enables an inexperienced user to create a high quality animated cartoon and eventually a cartoon channel in a short period of time using a first preferred setup (FIG. 1) that consists of:
1. A Smart Device: either a tablet or smart phone
2. A novel Device holder or “Stand” with a built-in mirror system for holding the Smart Device at a desired angle for the camera of the device to view and record, in real time, the physical movement/manipulation of multiple scene elements WHILE the scene is happening in front of the Device's camera on this holder/stand;
3. A plurality of physical characters C and/or scene props P (or other objects) and
4. A background scene S to represent the environment

The user of this system would be able create an animated cartoon by placing multiple physical characters and either physical or digital prop objects in a physical scene (we call it, a “studio”) as in the way a regular movie is normally shot. The smart device D will be placed, face (or main display) up, on its holder H or stand that has a mirror M built into its front most plane. That mirror M will be used to transfer the physical scene(s) from the studio to the camera of the smart Device while the Device rests on the stand. In other words, mirror M works to change the view angle of the Device's camera. Having the smart Device on this holder/stand frees the user's hand to manipulate/move the plurality of characters C₁, C₂, C₃ or prop objects P₁, P₂, P₃, P₄ in the scene for said system user to build (or otherwise create) his/her own animated story.

The camera for smart Device D will be taking a real time video stream of the “studio”. Then, through computer vision (i.e., a type of digital machine learning), the system will identify movable characters C and/or prop objects P in the given scene. In this first embodiment, all of these characters, physical objects and scene backgrounds would need to be scanned beforehand and saved in the software database stored on the device D so that when the camera, through computer vision, recognizes a previously scanned object, it will populate the digital scene on the smart Device with the recognized object.

Once the Characters and Prop objects are recognized digitally, a user would be able to move/manipulate the characters and/or prop objects about, in the digital scene, by moving the very physical characters and prop objects in front of the camera. The user can also switch scenes by removing a first physical background scene S₃ behind the characters and prop objects and replacing it with another one such as scenes S₁, S₂, S₄ or S₅. The change of the physical scene would also change the digital scene on the smart Device. Scenes can also be changed digitally without having to change the physical background scene.

The position of the physical items (both characters C and prop objects P) in the scene would also affect the way these physical items will interact with one another. For example, if you have a physical piano in the scene and you place a character next to that piano, nothing happens. But . . . the moment you place that same character behind the piano, the character will start playing the piano on the device's display screen. Note, if you place that same character in front of the piano, no interaction happens. The physical location of the objects—relative to the camera—determines the type of interaction, if any, that will be happening among the different characters and prop objects in the scene. The prop objects P can also be purely digital meaning that a character C would have the same interaction with a digital prop P as if the prop P also existed in the physical scene.

The innovation of this first embodiment is akin to what a computer mouse does when manipulating objects on a digital screen. But in this case, it is a tool that will allow the system's user to manipulate the characters and potentially prop objects in a physical setting for creating a high quality, animated cartoon video in a short period of time.

In the next, or second generation of this invention, the System tracks the relative distance, speed, direction and acceleration of the characters and/or prop objects positioned in front of the digital camera to the system's purposefully angled Device (or tablet) for creating special effects for these digitally controlled characters and/or prop objects for an even more sophisticated Animated Cartoon.

This second generation System allows a user to create special effects and even greater interactivity between digital characters and/or prop objects using the digital camera on the smart Device to monitor the relative distance, speed, direction and acceleration of physical items (characters and/or prop objects) positioned in front of the Device's camera.

This next generation invention consists of:
1. Software that runs on the smart Device.
2. Software that analyzes the relative distance of physical items placed in front of the Device's camera, such physical items being meant to represent digital characters or prop objects IN the software.
3. Software that analyzes the speed that the physical items move with, toward, or away from the camera thereby affecting the behavior or interaction of these digital characters and/or prop objects.
4. Software that analyzes the direction of the physical items when facing the digital camera.
5. Real world physics that analyzes the relative speed and acceleration of the physical items when they are moved about, thus affecting the behavior and/or interaction of these digital characters and/or prop objects.
6. The background for this next generation animated scene recorder can be a physical “green screen” or some sort of combination of physical AND digitally manipulative backdrop.

The user of this second system will be able create a special effects or a high level of character interactivity in a cartoon by placing one OR MORE objects in front of the digital camera of the smart Device (phone or tablet). These physical items will need to be mapped to their digital counterparts in the cartoon-making software used by this system. That software will then calculate the relative distances of the physical items and their acceleration through the viewing range of the digital camera. The calculated relative distance, orientation, acceleration and speed of the physical items will determine the interactivity of these digital characters and the effects that are created within the digital environment. The artificial intelligence implemented by this more advanced system will then help a cartoon creator automate and facilitate the creation of cartoon characters that may more closely resemble real world characters, or that would normally require a cartoon studio to hire a crew of artists, designers and animators for achieving a similar, or the same, level of interactivity and liveliness.

The digital camera will be: (a) taking a video stream of the items that are visible to the camera; and (b) analyzing the physical items to relay their relative positions to the digital characters and prop objects.

The physical items of this second system will also be able to transfer features or behavior to the accessories and digital props that may be tied to the digital characters. Also, the physical objects relative position, speed, and acceleration would affect the way the digital characters or objects interact with: (a) other digital characters, (b) prop objects or even (c) background scenes in the digital world.

Referring now to the accompanying drawings, FIG. 1 shows a first generation System wherein a plurality of background scenes S₁, S₂, S₃, S₄ and S₅ are situated behind a base B onto which a plurality of characters C₁, C₂, C₃ and prop objects P₁, P₂, P₃ and P₄ can be initially positioned, then moved about as desired for the making of any animated cartoon (video or movie).

Positioning a smart device D (or tablet) on a specially shaped (and angled) novel holder/stand H, resting the device D, main camera side down, on the rest support RS of that holder H, an animation can be made and recorded with the relative movements of the characters and/or prop objects about the base B. Their relative movements, as viewed via an angled mirror M, will translate to animated actions, sounds and the like of corresponding display characters DC₁, DC₂, DC₃ and/or display prop objects DP₁, DP₂, DP₃ and DP₄ as seen LIVE, in real time, on the display screen to device D.

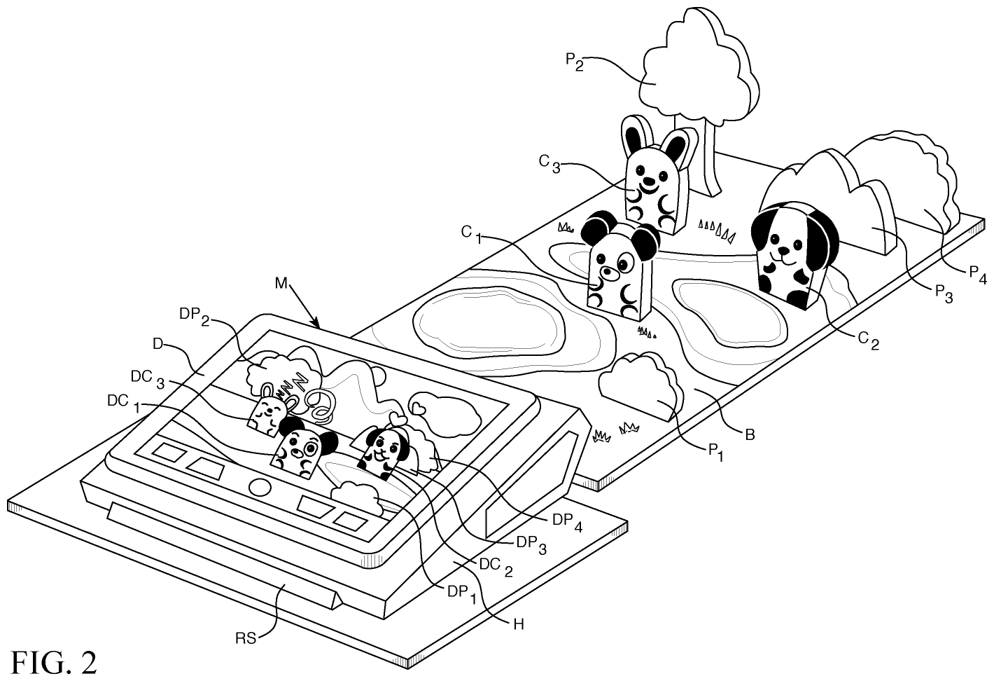

In the next generation of systems per this invention, per FIG. 2, there has been a digital replacement of physical background scenes with software-generated backgrounds on a device D mounted on its own holder H. Because of intelligent apps downloaded onto this device (for making short cartoon animations), the plurality of characters C₁, C₂, C₃ physically positioned onto the System's base B (with one or more physical and/or purely digital prop objects P₁, P₂, P₃ and P₄) will translate to differently moving, interacting on-screen display characters DC₁, DC₂, DC₃ as noted by their different facial expressions and emotion indicators (sleepy Z's, confused swirls and in-love raising hearts) on the display screen of device D.

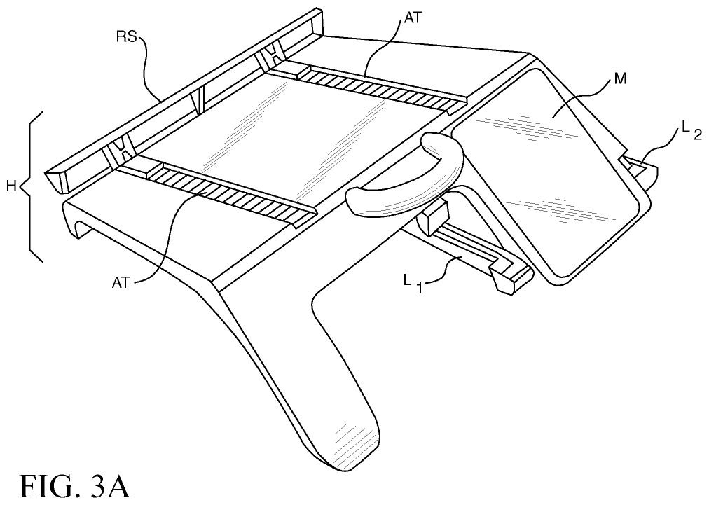

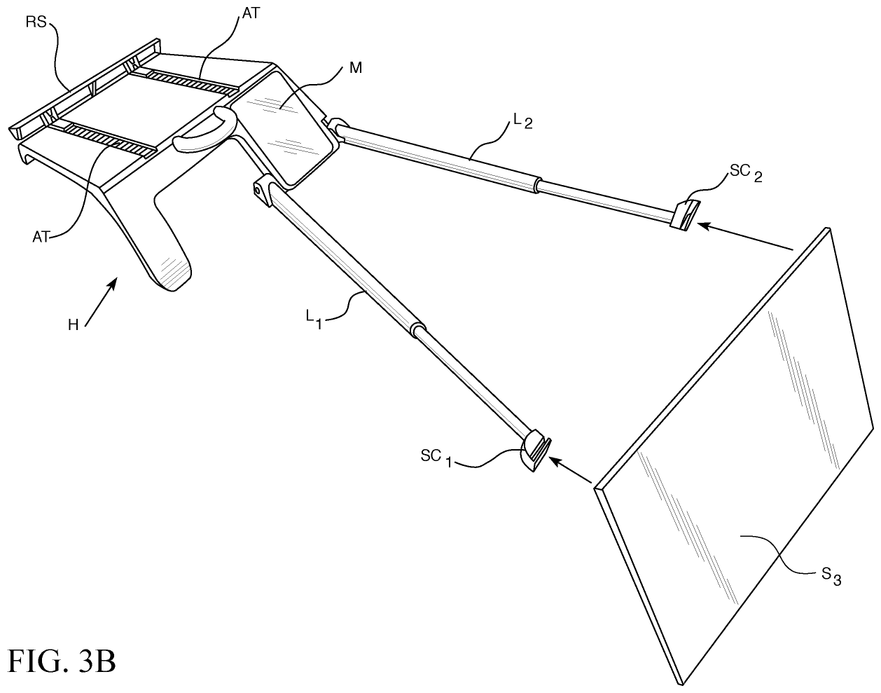

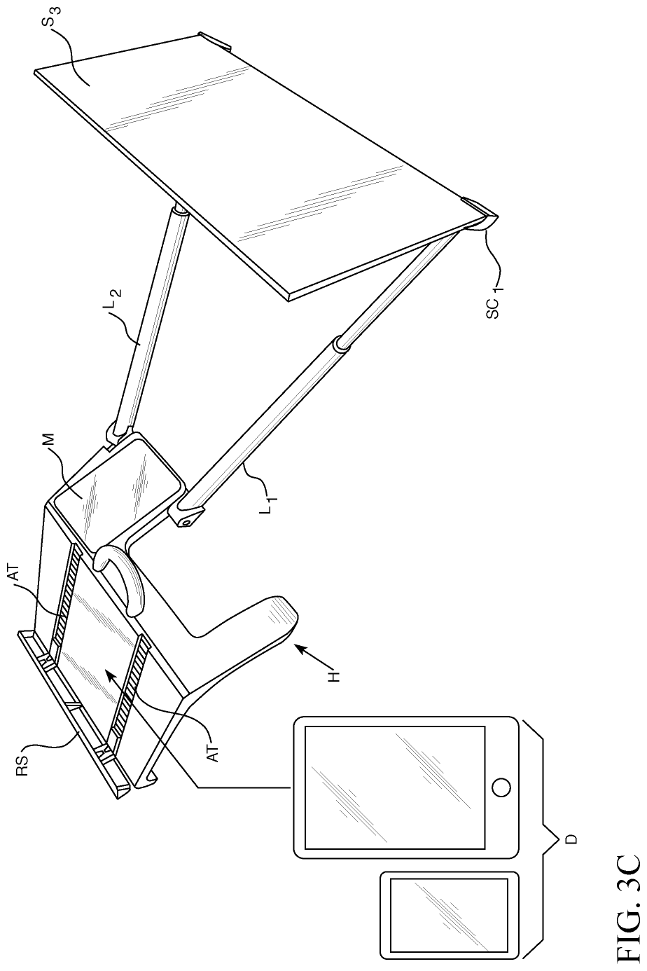

FIGS. 3A through C show one preferred arrangement of device holder H per this invention. Made from a section of angled/beveled plastic (metal or composite, in the alternative), holder H includes a device-holding plane region that terminates in a rest stop/shelf RS. That rest stop can be slid up or down along a pair of spaced apart, attenuated tracks AT in the device-holding plane region for differently sized, shaped and/or brands of smart devices (seen as element D in FIG. 3C).

Towards the angled front of holder H, there is situated a mirror M for receiving the action of movements occurring on the base of a System and transferring those movements, real time, to the camera of the device D. The holder H with its adjustable mirror system should be able to handle different types, sizes and/or models of smart devices (phones OR tablets). The holder's primary purpose is to change a device's camera view angle so the user can view a scene while the device is facing the ground, the floor or a table and keep the user/creator's hands free to effectively animate a cartoon story by manipulating the physical characters infront of the screen. The holder should also accommodate a smart device camera flash so that the flash light of the device proper can be turned on to improve the tracking of physical objects in front of the camera scene, or when the video recording environment is darker than preferred.

For optimally situating the one or more background scenes (such as S₃ in FIG. 3B) a desired distance away from the device's camera (and angled mirror M), holder H is provided with at least two telescopically extending legs L₁ and L₂ that retract and store beneath holder H when not in use. The front most ends to these legs are fitted with screen clips SC₁, SC₂ for both: (a) holding the background scene S₃ (or a Green Screen, in alternative embodiments; and (b) defining the area where the physical characters will first need to be placed, and then moved about, so that they can be seen BY the Device's camera. Together the extension of these legs, ON the holder, define the very field of vision so as to better accommodate different devices, with different cameras (and different camera angles/lenses, etc.)

### Example 1

A “tween” boy wants to create his own animated cartoon video or movie about a Formula 1® racing car. The boy purchases a System set that includes a background of the racing track, a racing car and a racing character. The boy downloads our mobile application and then places his own smart device on the holder/stand. Next, he builds a studio “setup” that includes placing the racing track background scene in an area in front of the holder/stand, and his racing character in front of the background scene facing the Device's camera on the holder/stand.

The boy starts recording the video/movie scene by pressing the record button on the downloaded Application. The racer and the racing track will show up on his digital screen. The boy then makes his racer say some words about his excitement for the race by clicking on the racer and selecting a talk icon that makes the racer talk in the boy's own voice.

The boy then physically moves his racer forward towards the camera. Next, he slides the racing car (prop) into the scene and it shows up on the Device's digital screen. When the boy next places his racer character IN the prop car, the car ON the digital screen starts moving forward. This all happens while the boy records his own animation video on the Device. After the boy stops recording, his own video is ready for publishing and sharing on YouTube® or any other social network. Using the System, it would have taken the boy roughly 2 minutes to create a 30 second, animated cartoon video.

### Example 2

A “tween” girl wants to create an animated cartoon video or movie about learning algebra in the classroom. The girl buys for her tablet several of our physical characters. The girl downloads our Intelligent App from one of the App stores. She then places the physical characters in front of the tablet which is on its holder/stand from our System. The way she moves the physical characters in front of that tablet relative to one another will affect their movement IN the digital scene.

The girl makes one of the characters the teacher. The moment she starts recording her video, she makes the digital teacher character talk. As the teacher talks in the cartoon video, the other characters automatically start looking at the teacher representing how eye movement would have occurred in a real world setting for real people.

### Example 3

A boy wants to create a cartoon video of characters racing one another in race cars. He places his smartphone on stand and purchases couple of our physical characters. The boy downloads our Intelligent App from the App store. The boy places the physical characters infront of the of the stand and he places the digital representation of those characters in a digital cars. As he moves the physical characters towards the camera, the speed that he moves the physical characters with affects the sounds that the digital race cars make while he is recording the cartoon video. The way the boy rotates the physical pets causes the digital race car to steer and make screeching sounds in the recorded cartoon video.

We claim:

1. A system for enabling a user to manipulate multiple characters, scenes and prop objects and create an animated cartoon on a smart device in real time, said system comprising:
(a) a smart device having a recording camera component;
(b) a plurality of movable characters;
(c) a plurality of prop objects;
(d) a smart device holder with at least one mirror for transposing physical movement of at least one of the plurality of movable characters and/or plurality of prop objects to the recording camera component of the smart device;
(e) at least one background scene against which physical movement of the at least one of the plurality of movable characters and/or plurality of prop objects may be viewed and recorded by the camera component of the smart device; and
(f) means for transposing physical movement of at least one of the plurality of movable characters relative to the prop objects and/or background scene into one or more animated action movements recordable, in real time, on the recording camera component of the smart device.

2. The system of claim 1 wherein at least one of the plurality of prop objects is a physical object.

3. The system of claim 1 wherein at least one of the plurality of prop objects is a digitally created prop object.

4. The system of claim 1 wherein the at least one background scene is a green screen board.

5. The system of claim 1 wherein the background scene is selected from a group of a plurality of physical background scenes for alternatingly positioning a select distance away from the recording camera component of the smart device.

6. The system of claim 1, which further includes a base onto which the at least one of the plurality of movable characters and/or plurality of prop objects may be situated and moved about relative to each other.

7. The system of claim 1 wherein the base is situated directly in front of the recording camera component of the smart device.

8. The system of claim 1 wherein a physical movement of one or more of the plurality of movable characters relative to the plurality of prop objects translates to a recordable animated action movement on a display screen of the smart device, said animated action movement being contingent on a relative position of the one or more movable characters to the prop object such that a desired animated action movement will only display when the one or more movable characters is in a first position relative to the prop object but not when the one or more movable characters is in a position other than the first position.

9. The system of claim 8 wherein the one or more movable characters will appear to interact with the prop object when the prop object is positioned between the one or more movable characters and the recording camera component of the smart device.

10. The system of claim 1, which enables replacing a second physical background scene for a first physical background scene in front of the recording camera component.

11. The system of claim 10 wherein replacing the second physical background scene for the first physical background scene translates to a different recordable animated action by movement of the same movable character with the same prop object.

12. The system of claim 10 wherein replacing the first physical background scene with the second physical background scene translates to a different recording camera angle for the recording camera component.

13. The system of claim 1 wherein relative positions of one or more of the plurality of movable characters to the other movable characters in a recordable action scene causes an interaction that happens digitally between the plurality of movable characters for recording on the smart device in real time.

14. The system of claim 13 wherein relative movements between the plurality of movable characters triggers recordable visual and/or audible interactions.

15. The system of claim 1, which enables hands-free recording on the smart device so that users may use their hands to manipulate one or more of the plurality of movable characters in the recordable animated action scene.

16. A system for enabling a user to manipulate multiple characters with digital prop objects and digital background scenes and create, using computer vision, a recordable animated cartoon on a smart device, said system comprising:
(a) a smart device having a recording camera component;
(b) a plurality of movable characters;
(c) a downloadable library with a plurality of digital prop objects;
(d) a smart device holder with at least one mirror for transposing physical movement of at least one of the plurality of movable characters relative to the plurality of digital prop objects in view of the recording camera component of the smart device;
(e) a downloadable library with a plurality of digital background scenes against which physical movement of the at least one of the plurality of movable characters may be viewed and recorded by the camera component of the smart device; and
(f) means for transposing physical movement of at least one of the plurality of movable characters relative to the digital prop objects and/or digital background scenes into recordable animated action movements using computer vision.

17. The system of claim 16, which further includes means for detecting at least one of: relative distances and relative accelerations between movable characters and relative speeds of movable character movements in front of the recording camera component on the smart device.

18. The system of claim 16, which further includes means for effecting different digital character expressions on the smart device depending on the relative distance, acceleration, speed of movable characters and/or prop objects in front of the recording camera component.

19. A method for making a recordable animated action video by manipulating one or more movable physical characters, one or more background scenes and/or one or more physical or digital prop objects in front of a recording camera component of a smart device in real time, said method comprising:
(a) providing the smart device having the recording camera component;
(b) providing a plurality of movable physical characters;
(c) providing a plurality of physical or digital prop objects;
(d) providing at least one physical or digital background scene against which physical movement of the one or more movable characters may be viewed and recorded by the recording camera component of the smart device;
(e) providing a device holder with an adjustable mirror for transposing physical movements of one or more of said movable physical characters relative to the background scenes and/or the physical or digital prop objects to the recording camera component for displaying on the smart device one or more recordable animated actions between the movable physical characters, the physical or digital prop objects;
(f) providing means for detecting physical movements of one or more of said movable physical characters relative to the background scenes and/or the physical or digital prop objects and converting such detected physical movements into one or more recordable animated actions on the smart device in real time;
(g) turning on an action recording component on the smart device; and
(h) manipulating physical movements of one or more of said movable physical characters relative to the background scenes and/or the physical or digital prop objects to make the recordable animated action video on the smart device.

20. The method of claim 19 wherein relative movements between the plurality of movable physical characters and/or the physical or digital prop objects triggers recordable visual and/or audible interactions.
